(19) United States
(12) Patent Application Publication
(10) Pub. No.: US 2002/0123268 A1
(43) Pub. Date: Sep. 5, 2002

(54) Horizontal electric connector

(75) Inventors: Keiji Kuroda, Amagasaki-shi (JP); Daichi Miyamoto, Nissin-shi (JP)

Correspondence Address: FASSE PATENT ATTORNEYS, P.A., P.O. BOX 726, HAMPDEN, ME, 04444-0726, US

(73) Assignee: J.S.T. Mfg. Co., Ltd., Osaka (JP)

(21) Appl. No.: 10/087,509

(22) Filed: Mar. 1, 2002

(30) Foreign Application Priority Data
Mar. 5, 2001 (JP) 2001-60986

(51) Int. Cl. H01R 24/00

(52) U.S. Cl. 439/637

(57) ABSTRACT

To prevent deformation of the leg of the second electric contact, which has a contacting part that is fixed to the insulating housing at a position lower than that of the first electric contact and the leg that extends from the contacting part, comes out of the insulating housing at the rear thereof and extends forwards along the bottom of the insulating housing.

A horizontal electric connector comprising an insulating housing, a first electric contact, which has a contacting part that is press-fitted into the insulating housing from the rear and contacts a counterpart conductive part, and a leg that extends from the contacting part, comes out of the insulating housing at the rear thereof and descends, a second electric contact, which has a contacting part that is press-fitted into the insulating housing from the rear at a position lower than that of the first electric contact and contacts a counterpart conductive part, and a leg that extends from the contacting part, comes out of the insulating housing at the rear thereof and extends forwards along the bottom of the insulating housing, and a leg supporting part, which is provided on the bottom of the insulating housing and into which the leg of the second electric contact is press-fitted from the rear.

### BACKGROUND OF THE INVENTION

1. Field of the Invention

The present invention belongs to a field of electric connectors that are horizontally mounted on a printed circuit board, etc., and relates to a structure for supporting electric contacts on an insulating housing.

2. Related Art

A horizontal electric connector is known as one of the above-mentioned horizontal electric connectors. This horizontal electric connector comprises an insulating housing, a first electric contact, which has a contacting part that is fixed on the insulating housing and contacts a counterpart contact, and a leg that extends from the contacting part, comes out of the insulating housing at the rear thereof and descends, and a second electric contact, which has a contacting part that is fixed on the insulating housing at a position lower than that of the first electric contact and contacts a counterpart contact, and a leg that extends from the contacting part, comes out of the insulating housing at the rear thereof and extends forwards along the bottom of the insulating housing (for example, refer to Japanese Utility Model unexamined publication gazette Heisei 1-160679). This horizontal electric connector is mounted on a printed circuit board by placing the horizontal electric connector on the printed circuit board, with the bottom of the horizontal electric connector facing a face of the printed circuit board, and soldering the connecting part at the top end of each leg onto a conductive part of the printed circuit board. When, as explained above, the leg of the second electric contact coming out of the insulating housing at the rear thereof is guided forwards, the distance between the connecting part of the second electric contact and the connecting part of the first electric connector can be made greater in comparison with a case wherein the leg of the second electric connector, which is coming out of the insulating housing at the rear thereof, is made to descend directly. Accordingly, even if the electric connector is subjected to a force in the front-rear direction by insertion or removal of a counterpart electric connector, the forces to which the connecting parts are subjected by the force will be reduced, and moreover, troubles such as short circuits caused by a solder waste or the like caught between the connecting parts can be prevented.

In the case of the above-mentioned horizontal electric connector, the length of the second electric contact from the part fixed to the insulating housing to the connecting part is longer in comparison with a case wherein the second electric contact descends directly at the rear of the insulating housing. Because of this, the leg tends to be deformed due to external forces. If the leg is deformed, the bottom of the leg and the bottoms of legs of other second electric contacts will become irregular to each other, losing the coplanarity, or increasing the possibility of defective connection and short circuit. Herein, obtaining the coplanarity means that the faces of the electric contacts, which contact a printed circuit board or the like, constitute a single plane.

### SUMMARY OF THE INVENTION

The present invention was made in view of these points, and one objective of the invention is to provide a horizontal electric connector that can stably obtain the coplanarity of the second electric contacts and reliably prevent defective connection and short circuit by supporting the leg of the second electric contact on the bottom of the insulating housing and preventing deformation of the leg in both the height direction and the width direction.

To accomplish the above-mentioned objective, the horizontal electric connector according to the present invention comprises an insulating housing having a front, a rear and a bottom, a first electric contact, which has a contacting part that is press-fitted into the insulating housing from the rear and contacts a counterpart conductive part, and a leg that extends from the contacting part, comes out of the insulating housing at the rear thereof and descends, a second electric contact, which has a contacting part that is press-fitted into the insulating housing from the rear at a position lower than that of the first electric contact and contacts a counterpart conductive part, and a leg that extends from the contacting part, comes out of the insulating housing at the rear thereof and extends forwards along the bottom of the insulating housing, and a leg supporting part, which is provided on the bottom of the insulating housing and into which the leg of the second electric contact is press-fitted from the rear.

When this horizontal electric connector is placed in such a way that its bottom faces a printed circuit board or the like, and the connecting parts at the top ends of the legs of the first electric contact and the second electric contact are soldered onto the printed circuit board or the like, the horizontal electric connector will be mounted onto the printed circuit board or the like. In this case, as the leg of the second electric contact extends forwards along the bottom, even if the horizontal electric connector is subjected to a force in the front-rear direction, the forces to which the connecting parts will be subjected will be reduced, and moreover, troubles, such as short circuit caused by a solder waste or the like caught between the connecting parts will be prevented. Furthermore, as the leg of the second electric contact is press-fitted into the leg supporting part on the bottom of the insulating housing from the rear, the leg will hardly undergo deformation in the height direction and the width direction. As a result, the coplanarity of the second electric contacts will be obtained reliably and defective connection and short circuit will be prevented.

Accordingly, the horizontal electric connector according to the present invention can reduce the force to which the connecting parts are subjected when the connector is subjected to a force in the front-rear direction because the leg of the second electric contact extends along the bottom of the connector. Moreover, the horizontal electric connector of the present invention can prevent occurrence of troubles such as a short circuit between connecting parts due to a solder waste, etc. As the leg of the second electric contact is supported on the bottom of the insulating housing, the leg hardly undergoes deformation in the height direction and the width direction, and the coplanarity of the second electric contacts can be obtained stably, and defective connection and short circuit can be prevented reliably.

### BRIEF DESCRIPTION OF THE DRAWINGS

FIG. 1 is a perspective view of an embodiment of the horizontal electric connector according to the present invention.

FIG. 2 is a front view of the embodiment of the horizontal electric connector.

FIG. 3 is a bottom view of the embodiment of the horizontal electric connector.

FIG. 4 is a side view of the embodiment of the horizontal electric connector.

FIG. 5 is an enlarged view of the embodiment of the horizontal electric connector. It is sectioned longitudinally and seen from its side.

FIG. 6 is an enlarged perspective view of a portion around the leg supporting part of the embodiment of the horizontal electric connector. It is seen from the lower front.

FIG. 7 is an enlarged perspective view of a portion around the leg supporting part of the embodiment of the horizontal electric connector. It is seen from the lower rear.

FIG. 8 is an enlarged front view of a portion around the leg supporting part of the embodiment of the horizontal electric connector.

FIG. 9 is an enlarged bottom view of a portion around the leg supporting part of the embodiment of the horizontal electric connector.

FIG. 10 is an enlarged perspective view of the second electric contact of the embodiment of the horizontal electric connector.

FIG. 11 is a perspective view of the insulating housing of the embodiment of the horizontal electric connector.

FIG. 12 is an enlarged perspective view showing the second electric contact being assembled into the insulating housing of the embodiment of the horizontal electric connector.

### DESCRIPTION OF PREFERRED EMBODIMENTS OF THE INVENTION

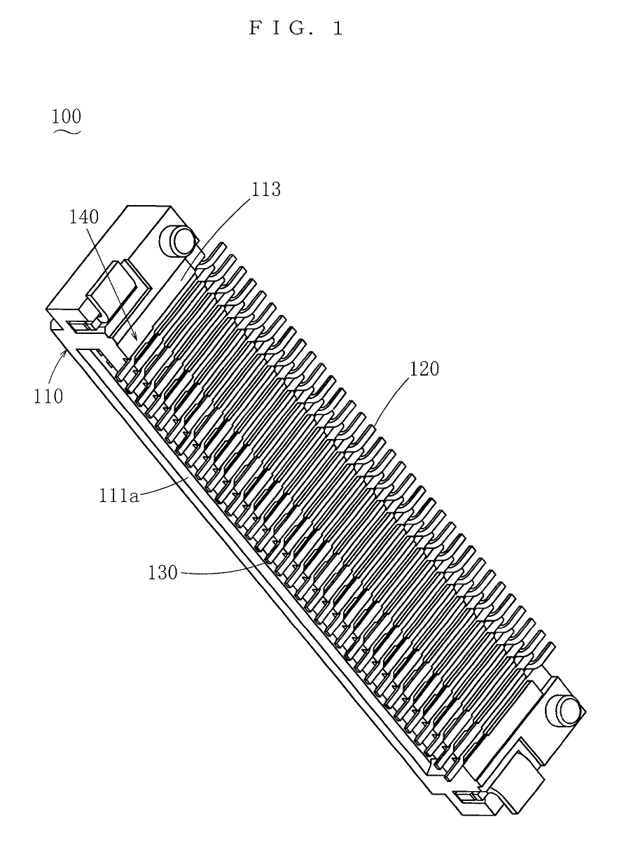

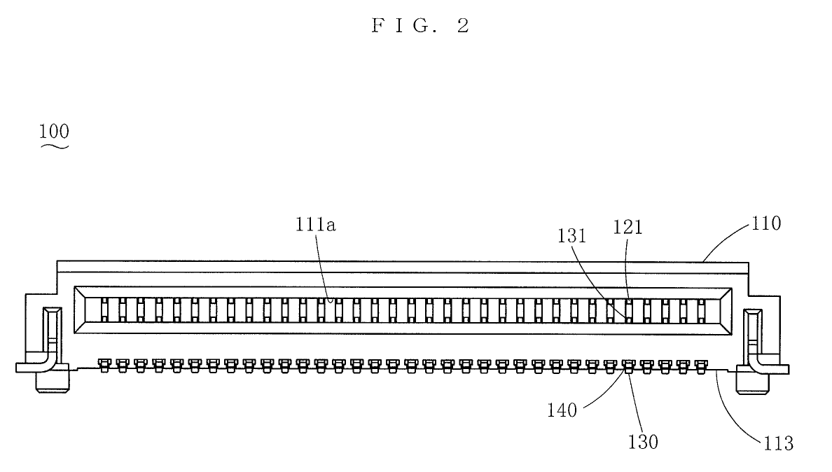

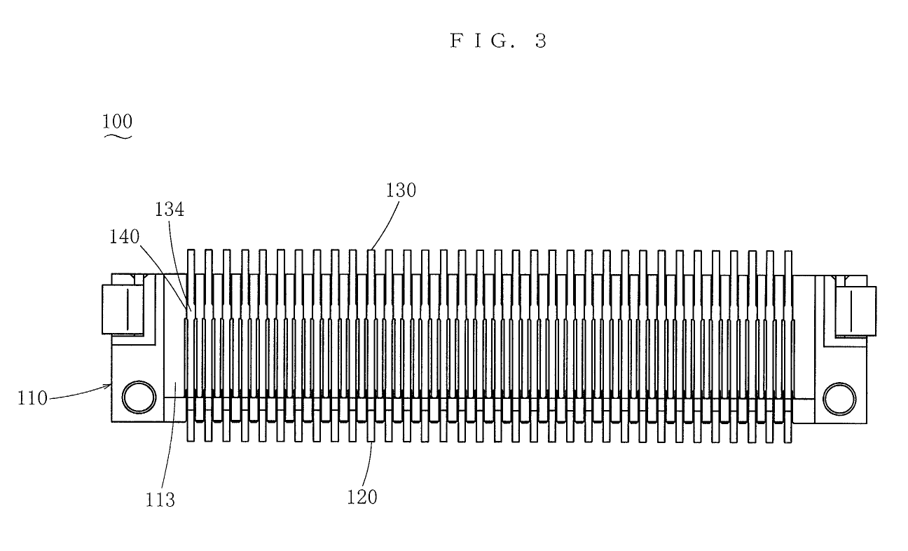

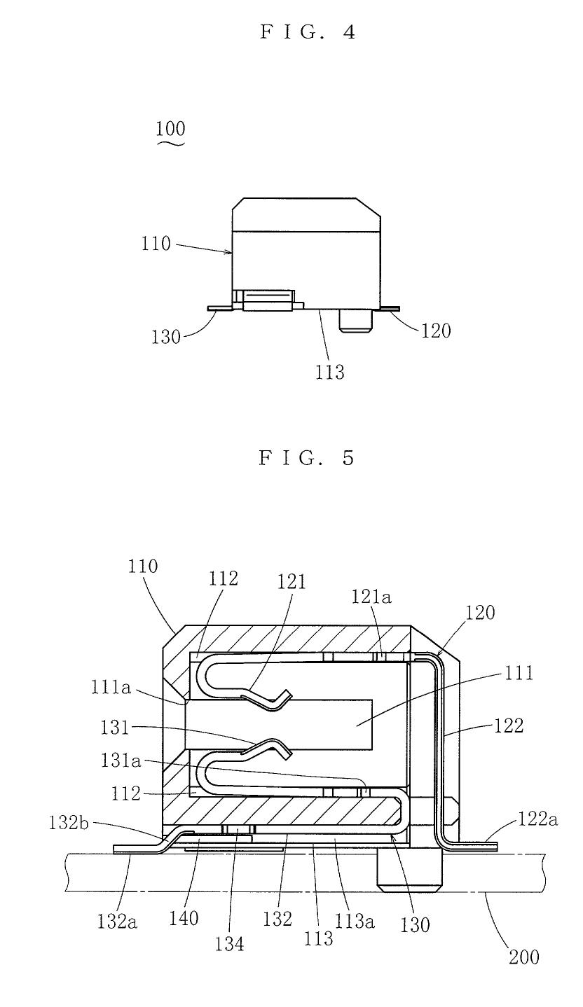

In the following, some embodiments of the present invention will be described. FIG. 1 through FIG. 4 show a horizontal electric connector 100 being the embodiment. This electric connector 100 is a card-edge connector which is to be horizontally mounted on a printed circuit board 200, and the top end of an IC card or the like will be inserted, in a direction almost in parallel with the printed circuit board 200, into the electric connector 100 through an insertion port that opens in one end of the electric connector 100.

In FIG. 1 through FIG. 4, 110 denotes an insulation housing that is formed of an insulating material such as resin. A chamber 111 is formed in this insulating housing 110. The chamber 111 is open rearwards. A receiving port 111a for receiving an IC card or the like, which is through to the chamber 111, is formed at the front of the insulating housing 110. A first electric contact 120 and a second electric contact 130 are press-fitted into the insulating housing 110 from the rear thereof. In this way, portions of the first electric contact 120 and the second electric contact 130 that are exposed forwards through the receiving port lila are reduced. At least a pair of the first electric contact 120 and the second electric contact 130 are provided, and the first electric contact 120 is press-fitted on an upper side and the second electric contact 130 on a lower side, respectively.

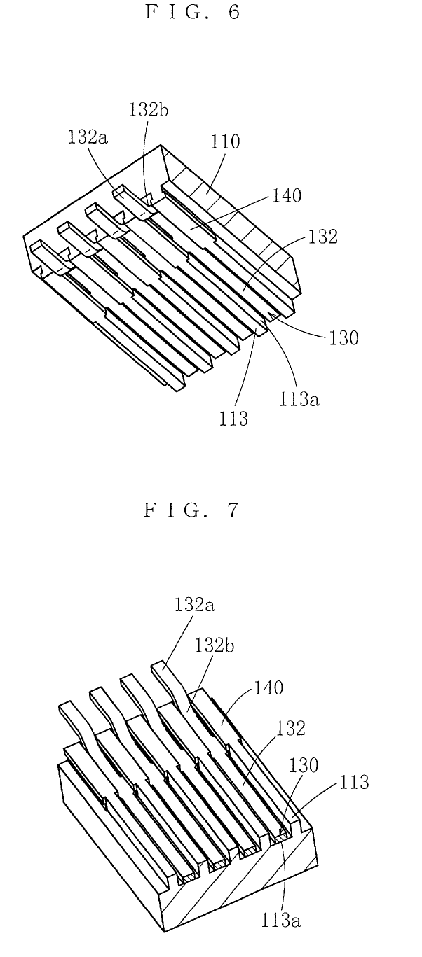

As shown in FIG. 5, the first electric contact 120 is provided with a contacting part 121 and a leg 122. The contacting part 121 is press-fitted into the insulating housing 110 from the rear thereof and contacts a counterpart conductive part being a conductive part of an IC card or the like. A wider press-fitting part 121a is formed in the contacting part 121, and this press-fitting part 121a is press-fitted into a press-fitting groove 112 on the insulating housing 110. The leg 122 extends from this contacting part 121, comes out of the insulating housing 110 at the rear thereof and descends. A connecting part 122a, which is to be soldered onto the printed circuit board 200, is formed at the top end of the leg 122. The second electric contact 130 is provided with a contacting part 131 and a leg 132. The contacting part 131 is press-fitted into the insulating housing 110 from the rear thereof, at a position that is lower than that of the first electric contact 120, and contacts a counterpart conductive part being a conductive part of the IC card or the like. A wider press-fitting part 131a is formed in the contacting part 131, and this press-fitting part 131a is press-fitted into a press-fitting groove 112 of the insulating housing 110. The leg 132 extends from the contacting part 131, comes out of the insulating housing 110 at the rear thereof, and extends forwards along the bottom 113 of the insulating housing 110. A connecting part 132a, which is to be soldered onto the printed circuit board 200, is formed at the top end of the leg 132.

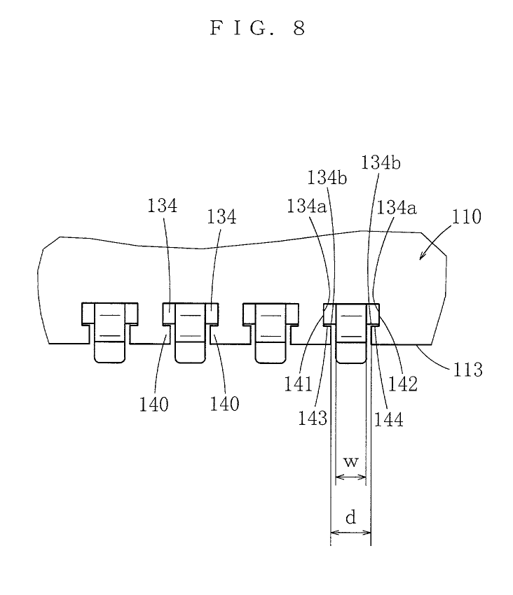

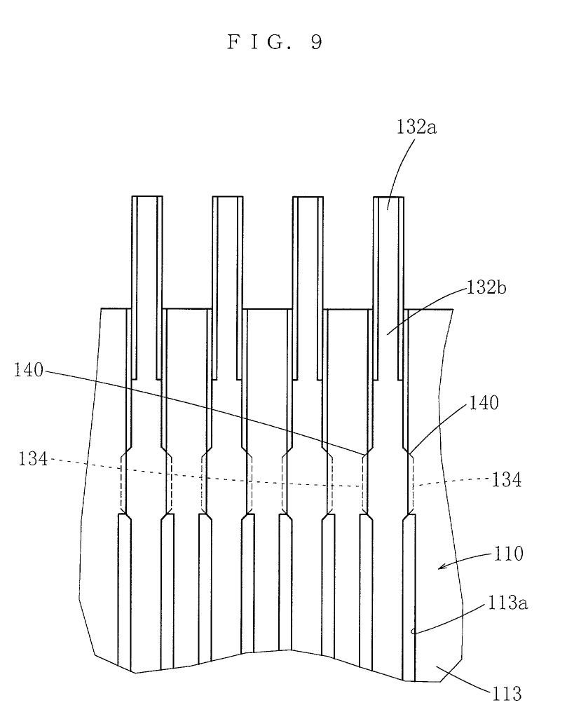

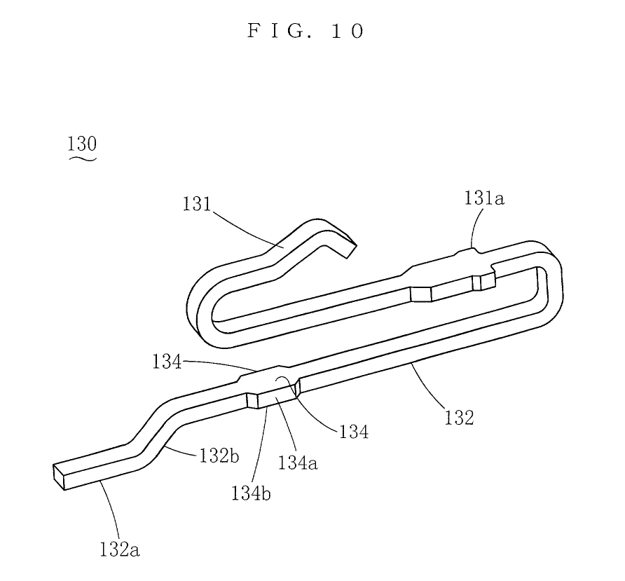

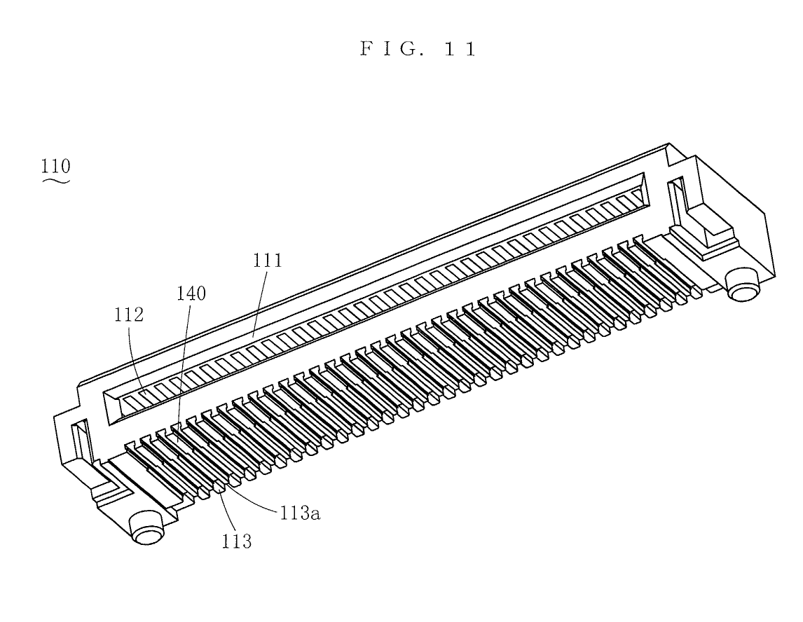

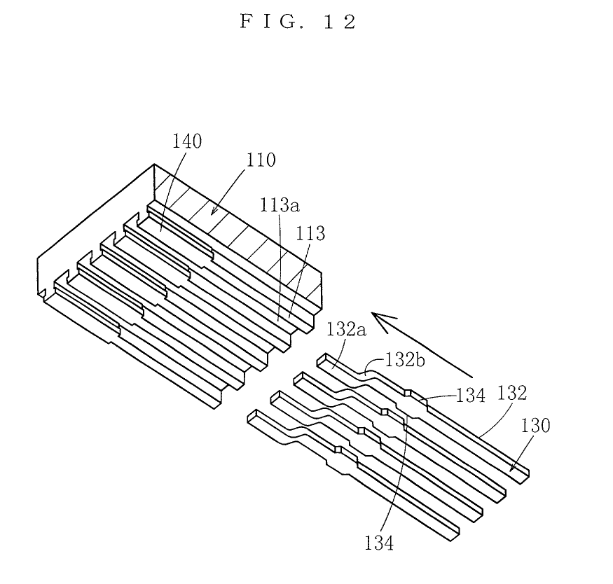

As shown in FIG. 6 through FIG. 9, a leg supporting part 140, into which the leg 132 of the second electric contact 130 is press-fitted from the rear, is provided on the bottom 113 of the insulating housing 110. The leg 132 of the second electric contact 130 comes out of the insulating housing 110 at the rear thereof, extends forwards along the bottom 113 of the insulating housing 110, and then descends away from the bottom 113 downwards, and a connecting part 132a is formed at the top end of the leg 132. Protruding parts 134, which protrude on both sides in the width direction, are formed in the part of the leg 132, which is along the bottom 113 of the insulating housing 110. As shown in FIG. 9 and FIG. 10, the protruding parts 134 on both sides may be formed at the same position in the front-rear direction or may be staggered from each other in the front-rear direction. The leg supporting part 140 is provided with a left vertical wall 141, a right vertical wall 142, which contact faces 134a in the width direction of the protruding parts 134, and horizontal walls 143, 144, which extend sidewise from the vertical walls 141, 142 and contact the bottoms 134b of the protruding parts 134 and are apart from each other by a distance d, which is not less than the width w of the descending part 132b of the leg 132 (namely d≧w).

As shown in FIG. 5 through FIG. 9, a guide groove 113a, which holds the leg 132 of the second electric contact 130, is formed in the bottom 113 of the insulating housing 110, and the leg supporting part 140 is formed on this guide groove 113a. The leg supporting part 140 is provided in the front part of the bottom 113 of the insulating housing 110. In other words, the guide groove 113a having a U-shaped section is formed in the insulating housing 110 from the rear face to the front face of the insulating housing 110. The width of the guide groove 113a corresponds to the distance from the face 134a of one protruding part 134 of the leg 132 to the face 134a of the other protruding part 134. In the front part of the guide groove 113a, the left and right vertical walls of the guide groove 113a constitute the left and right vertical walls 141, 142 of the leg supporting part 140. Moreover, at the bottoms of the left and right vertical walls of the guide groove 113a, horizontal walls extend towards the opposing vertical walls, and the top ends of these horizontal walls are apart by the distance d, which is not less than the width w of the descending part 132b of the leg 132. These horizontal walls constitute the horizontal walls 143, 144 of the leg supporting part 140.

Accordingly, when the horizontal electric connector 100 according to the embodiment is placed on the printed circuit board 200 in such a way that the bottom 113 of the connector 100 faces the board 200, the connecting parts 122a, 132a at the top ends of the legs 122, 132 of the first electric connector 120 and the second electric connector 130 are soldered onto the printed circuit board 200, the horizontal electric connector 100 will be mounted onto the printed circuit board 200. In this case, as the leg 132 of the second electric contact 130 extends forwards along the bottom 113, even if the horizontal electric connector 100 is subjected to a force in the front-rear direction, the forces which the connecting parts 122a, 132a receive will be reduced, and troubles such as short circuit between the connecting parts 122a, 132a due to a solder waste, etc. will be prevented. Moreover, as the leg 132 of the second electric contact 130 is press-fitted into the leg supporting part 140 from the rear at the bottom 113 of the insulating housing 110, the leg 132 will hardly undergo deformation in the height direction and the width direction. Hence the coplanarity of the second electric contacts 130 will be obtained reliably and defective connection and short circuit will be prevented.

The present invention includes embodiments of the horizontal electric connector wherein the portion of the leg of the second electric contact, which extends forwards along the bottom of the insulating housing, is linear. In contrast to them, in the horizontal electric connector 100 of the above-mentioned embodiment, the leg 132 of the second electric contact 130 first extends forwards along the bottom 113 of the insulating housing 110 and then descends away from the bottom 113 downwards, and the part of the leg 132 that extends along the bottom 113 of the insulating housing 110 is provided with protruding parts 134 that protrude on both sides in the width direction. Moreover, the leg supporting part 140 is provided with the left and right vertical walls 141, 142, which contact the faces 134a in the width direction of the protruding parts 134, and horizontal walls 143, 144, which extend sidewise from the respective vertical walls 141, 142, contact the bottoms 134b of the protruding parts 134a and are apart from each other by a distance that is not less than the width of the descending part 132b of the leg 132. With this arrangement, as shown in FIG. 12, when the second electric contact 130 is to be assembled into the insulating housing 110, if the second electric contact 130 is brought to the insulating housing 110 from the rear thereof, the descending part 132b of the leg 132 will pass between the horizontal walls 143, 144 of the leg supporting part 140 and move forwards, and the protruding parts 134 will be inserted into a space between the bottom 113 of the insulating housing 110 and the horizontal walls 143, 144 of the leg supporting part 140 and between the vertical walls 141, 142 of the leg supporting part 140. Hence displacement of the protruding parts 134 in the height direction will be limited between the bottom 113 of the insulating housing 110 and the horizontal walls 143, 144 of the leg supporting part 140, and displacement thereof in the width direction will be limited between the vertical walls 141, 142 of the leg supporting part 140.

The present invention includes embodiments wherein the portion of the bottom of the insulating housing along which the leg of the second electric contact extends is formed flat in the width direction. In contrast to them, in the horizontal electric connector 100 of the above-mentioned embodiment, the guide groove 113a for holding the leg 132 of the second electric contact 130 is formed in the bottom 113 of the insulating housing 110, and the guide groove 113a is provided with the leg supporting part 140. With this arrangement, as shown in FIG. 12, when the second electric contact 130 is to be assembled into the insulating housing 110, if the second electric contact 130 is brought to the insulating housing 110 from the rear, the leg 132 will be guided along the guide groove 113a into the leg supporting part 140. Hence the workability of assembly is good, and deformation of the second electric contact 130 will be prevented during assembly.

The present invention includes embodiments wherein the leg supporting part is provided in the middle part or the rear part of the bottom of the insulating housing. In contrast to them, in the horizontal electric connector 100 of the above-mentioned embodiment, the leg supporting part 140 is provided in the front part of the bottom 113 of the insulating housing 110. With this arrangement, as shown in FIG. 12, when the second electric contact 130 is to be assembled into the insulating housing 110, if the second electric contact 130 is brought to the insulating housing 110 from the rear, the second electric contact 130 will be press-fitted into the leg supporting part in the last stage of the assembling procedure. Hence the workability of assembly is good, and the second electric contact 130 will be prevented from deformation during assembly.

In the above-mentioned embodiment, the present invention was described by applying the invention to a card-edge connector into which or from which an IC card or the like is inserted or extracted. The present invention can also be applied, for example, to male or female horizontal electric connectors into which or from which a counterpart electric connector is inserted or extracted. In such a case, the conductive part of the counterpart is a male or female electric contact of the counterpart electric connector. Moreover, the present invention is extensively applicable to horizontal electric connectors having a structure wherein the electric contacts are press-fitted into the insulation housing from the rear. Hence the present invention includes embodiments wherein the chamber and the receiving port of the above-mentioned embodiment are not provided. The present invention also includes embodiments wherein the insulating housing is provided with a plurality of the first electric contacts being arranged in an upper layer and a lower layer and the second electric contacts are press-fitted into the insulating housing from the rear at positions being lower than those of the first electric contacts.

With the description of these embodiments, the first horizontal electric connector, which was described in the summary of the invention, has been fully disclosed. Moreover, with the description of these embodiments, the second through fourth horizontal electric connectors, which will be described below, have been fully explained.

The second horizontal electric connector is a horizontal electric connector as recited in the above-mentioned first horizontal electric connector, wherein the leg of the second electric contact has a width and extends forwards along the bottom of the insulating housing then descends away from the bottom downwards, the part of the leg extending along the bottom of the insulation housing is provided with protruding parts which protrude on both sides in the width direction, and the leg supporting part is provided with a left vertical wall and a right vertical wall, which contact faces in the width direction of the protruding parts, and horizontal walls, which extend sidewise from the vertical walls and contact the bottoms of the protruding parts and are apart from each other by a distance which is not less than the width of the descending part of the leg. With this arrangement, when the second electric contact is to be assembled into the insulating housing, if the second electric contact is brought to the insulating housing from the rear, the descending part of the leg will pass between the horizontal walls of the leg supporting part to move forwards, and the protruding parts will be inserted into a space between the bottom of the insulating housing and the horizontal walls of the leg supporting part and between the vertical walls of the leg supporting part. Hence deformation of the protruding parts will be limited in the height direction between the bottom of the insulating housing and the horizontal walls of the leg supporting part and in the width direction between the vertical walls of the leg supporting part. Accordingly, the present invention is applicable to a horizontal electric connector wherein a part descending from the bottom downwards is provided at the top of the part of the leg of the second electric contact extending along the bottom of the insulating housing.

The third horizontal electric connector is a horizontal electric connector as recited in the above-mentioned first or second horizontal electric connector, wherein a guide groove for holding the leg of the second electric contact is formed in the bottom of the insulating housing, and the guide groove is provided with the leg supporting part. With this arrangement, when the second electric contact is to be assembled into the insulating housing, if the second electric contact is brought to the insulating housing from the rear, the leg will be guided into the leg supporting part along the guide groove. As the leg of the second electric contact can be guided smoothly into the leg supporting part along the guide groove, the workability of assembly is good and deformation of the second electric contact can be prevented during assembly.

The fourth horizontal electric connector is a horizontal electric connector as recited in any one of the above-mentioned first through third horizontal electric connectors, wherein the leg supporting part is provided in the front part of the bottom of the insulating housing. With this arrangement, when the second electric contact is to be assembled into the insulating housing, if the second electric contact is brought to the insulating housing from the rear, the second electric contact will be press-fitted into the leg supporting part in the final stage of the assembling procedure. Hence the workability of assembly is good, and deformation of the second electric contact at the time of assembly will be prevented.

What is claimed is:

1. A horizontal electric connector comprising
an insulating housing having a front, a rear and a bottom,
a first electric contact, which has a contacting part that is press-fitted into the insulating housing from the rear and contacts a counterpart conductive part, and a leg that extends from the contacting part, comes out of the insulating housing at the rear thereof and descends,
a second electric contact, which has a contacting part that is press-fitted into the insulating housing from the rear at a position lower than that of the first electric contact and contacts a counterpart conductive part, and a leg that extends from the contacting part, comes out of the insulating housing at the rear thereof and extends forwards along the bottom of the insulating housing, and
a leg supporting part, which is provided on the bottom of the insulating housing and into which the leg of the second electric contact is press-fitted from the rear.

2. A horizontal electric connector as recited in claim 1, wherein
the leg of the second electric contact has a width and extends forwards along the bottom of the insulating housing then descends away from the bottom downwards,
the part of the leg extending along the bottom of the insulation housing is provided with protruding parts which protrude on both sides in the width direction, and
the leg supporting part is provided with a left vertical wall and a right vertical wall, which contact faces in the width direction of the protruding parts, and horizontal walls, which extend sidewise from the vertical walls and contact the bottoms of the protruding parts and are apart from each other by a distance which is not less than the width of the descending part of the leg.

3. A horizontal electric connector as recited in claim 1, wherein
a guide groove for holding the leg of the second electric contact is formed in the bottom of the insulating housing, and the guide groove is provided with the leg supporting part.

4. A horizontal electric connector as recited in claim 2, wherein
a guide groove for holding the leg of the second electric contact is formed in the bottom of the insulating housing, and the guide groove is provided with the leg supporting part.

5. A horizontal electric connector as recited in claim 1, wherein
the leg supporting part is provided in the front part of the bottom of the insulating housing.

6. A horizontal electric connector as recited in claim 2, wherein
the leg supporting part is provided in the front part of the bottom of the insulating housing.

7. A horizontal electric connector as recited in claim 3, wherein
the leg supporting part is provided in the front part of the bottom of the insulating housing.

8. A horizontal electric connector as recited in claim 4, wherein
the leg supporting part is provided in the front part of the bottom of the insulating housing.
